(19) United States
(12) Patent Application Publication
(10) Pub. No.: US 2025/0053878 A1
(43) Pub. Date: Feb. 13, 2025

(54) LEARNING DEVICE, MANAGEMENT SHEET CREATION SUPPORT DEVICE, NON-TRANSITORY COMPUTER-READABLE STORAGE MEDIUM, LEARNING METHOD, AND MANAGEMENT SHEET CREATION SUPPORT METHOD

(71) Applicant: Mitsubishi Electric Corporation, Tokyo (JP)

(72) Inventor: Hayato UCHIDE, Tokyo (JP)

(73) Assignee: Mitsubishi Electric Corporation, Tokyo (JP)

(21) Appl. No.: 18/918,690

(22) Filed: Oct. 17, 2024

Related U.S. Application Data
(63) Continuation of application No. PCT/JP2022/021535, filed on May 26, 2022.

(51) Int. Cl. G06N 20/00

(52) U.S. Cl. CPC G06N 20/00

(57) ABSTRACT

A device includes: a storage unit that stores a past case sheet created in the past as a management sheet that includes rows, each of which includes at least operation process information indicating one operation process and a risk sentence indicating information about a risk in the one operation process; a training data generating unit that generates correspondence relationship training data, which includes a positive example and a negative example, the positive example being a combination of the operation process information included in one of the rows in the past case sheet and the risk sentence included in the one row, the negative example being a combination of the operation process information included in the one row and the risk sentence included in a row different from the one row; and a correspondence relationship learning unit that generates a correspondence relationship model by using the correspondence relationship training data.

### CROSS REFERENCE TO RELATED APPLICATION

This application is a continuation application of International Application No. PCT/JP2022/021535 having an international filing date of May 26, 2022, which is hereby expressly incorporated by reference into the present application.

### BACKGROUND OF THE INVENTION

### 1. Field of the Invention

The present disclosure relates to a learning device, a management sheet creation support device, a non-transitory computer-readable storage medium, a learning method, and a management sheet creation support method.

### 2. Description of the Related Art

Conventionally, in Failure Mode Effect Analysis (FMEA), a quality management method using an FMEA sheet has been employed to predict potential failures during a design stage or an execution stage of a process and to identify necessary countermeasures to be taken.

FMEA sheets are often written based on the operator's knowledge or experience or from past failure cases and the like. However, relying too heavily on the operator's knowledge or experience can result in variations in the contents of the FMEA sheet depending on the operator and may lead to the risk of the FMEA sheet missing failures that the operator has not experienced. In addition, when referring to past cases, it is not easy to specify a document suitable for creating the sheet from numerous documents, and this process can be significantly time-consuming and labor-intensive.

Patent Reference 1 discloses a support system designed to assist in the creation of FMEA sheets. When a user designates a relevant part of documents to be read out in the FMEA sheet, the support system creates reference text data using text data entered in the designated part and also creates reference feature data that maps the relationship between words in the text to its strength of relevance. The support system then creates similar feature data for failure case documents which are to be searched for, calculates the degree of similarity between the reference feature data and the feature data about each failure case document, and outputs a failure case document with the highest degree of similarity.
Patent Reference 1: Japanese Patent Application Publication No. 2011-8355

### SUMMARY OF THE INVENTION

However, conventional support systems have been creating feature quantities, which are to be used for text search, solely from text information on FMEA sheets while considering neither the structural features of the FMEA sheets nor FMEA sheets that have been created in the past. As a result, there have been cases where useful information could not be provided to the user.

Therefore, one or more aspects of the present disclosure aim to provide more useful information when a user creates a management sheet.

A learning device according to one aspect of the present disclosure includes: storage to store a past case sheet created in a past as a management sheet, the management sheet including a plurality of rows, each of the plurality of rows including at least operation process information indicative of one operation process included in a plurality of operation processes and a risk sentence indicative of information about a risk in the one operation process; a processor to execute a program; and a memory to store the program which, when executed by the processor, performs processes of, generating correspondence relationship training data, which is training data including a positive example and a negative example, the positive example being a combination of the operation process information included in one of the plurality of rows in the past case sheet and the risk sentence included in the one row, the negative example being a combination of the operation process information included in the one row and the risk sentence included in a row different from the one row; and generating a correspondence relationship model by learning a correspondence relationship between the operation process information and the risk sentence by using the correspondence relationship training data.

According to one or more aspects of the present disclosure, more useful information can be provided to a user when the user creates a management sheet.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating a configuration of an FMEA sheet creation support device according to a first embodiment;

FIG. 2 is a schematic diagram illustrating an FMEA sheet;

FIGS. 3A and 3B are schematic diagrams, each illustrating an example of concatenated sequence data;

FIGS. 4A and 4B are schematic diagrams, each illustrating an example of replaced concatenated sequence data;

FIG. 5 is a schematic diagram for explaining machine learning in an integrated feature learning unit 112;

FIG. 6 is a first schematic diagram for explaining machine learning in a correspondence relationship learning unit;

FIG. 7 is a second schematic diagram for explaining machine learning in the correspondence relationship learning unit;

FIGS. 8A and 8B are schematic diagrams for explaining processing performed in a correspondence relationship estimation unit;

FIG. 9 is a block diagram illustrating an example of a computer;

FIG. 10 is a block diagram schematically illustrating a configuration of an FMEA sheet creation support device according to a second embodiment;

FIGS. 11A and 11B are schematic diagrams, each illustrating an example of expanding integrated feature training data;

FIG. 12 is a block diagram schematically illustrating a configuration of an FMEA sheet creation support device according to a third embodiment;

FIG. 13 is a schematic diagram illustrating an example of additional concatenated sequence data; and

FIG. 14 is a block diagram schematically illustrating a configuration of an FMEA sheet creation support device according to a fourth embodiment.

### DETAILED DESCRIPTION OF THE INVENTION

### First Embodiment

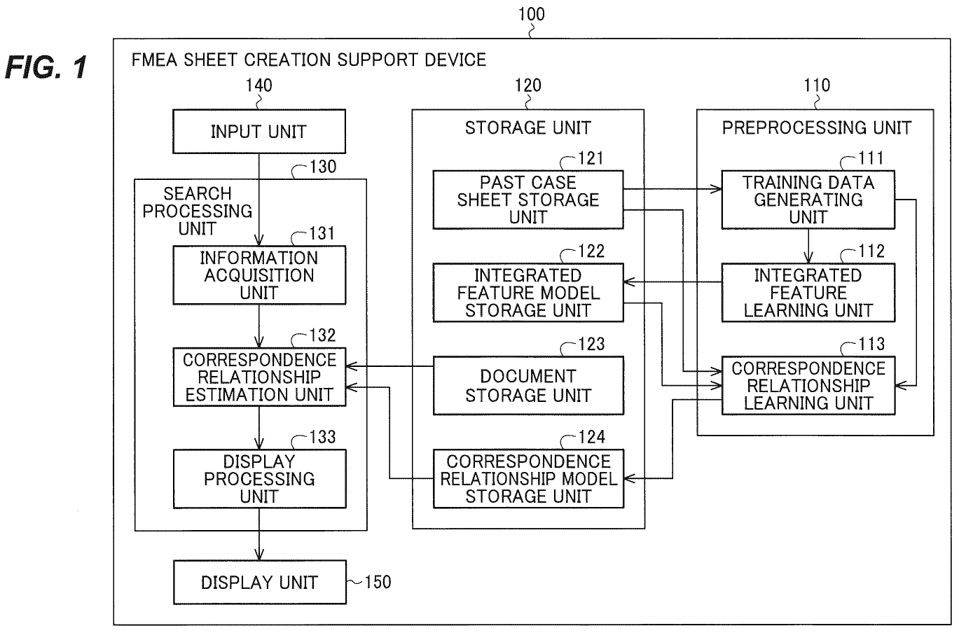

FIG. 1 is a block diagram schematically illustrating a configuration of an FMEA sheet creation support device 100 according to a first embodiment.

The FMEA sheet creation support device 100 includes a preprocessing unit 110, a storage unit 120, a search processing unit 130, an input unit 140, and a display unit 150.

The preprocessing unit 110 functions as a learning unit that learns learning models to be used in the search processing unit 130.

The preprocessing unit 110 includes a training data generating unit 111, an integrated feature learning unit 112, and a correspondence relationship learning unit 113.

The training data generating unit 111 generates training data to be used for learning. Here, the training data generating unit 111 generates integrated feature training data, which is the training data for learning in the integrated feature learning unit 112, as well as correspondence relationship training data, which is the training data for learning in the correspondence relationship learning unit 113.

Here, an FMEA sheet is first described.

In FMEA, a table-format management sheet, called the FMEA sheet, is created to conduct quality management. In the FMEA sheet, the contents of various types of failures are sorted and entered into a plurality of items. In addition, one or more items are set for specific solutions to the failures, and necessary information is entered therein.

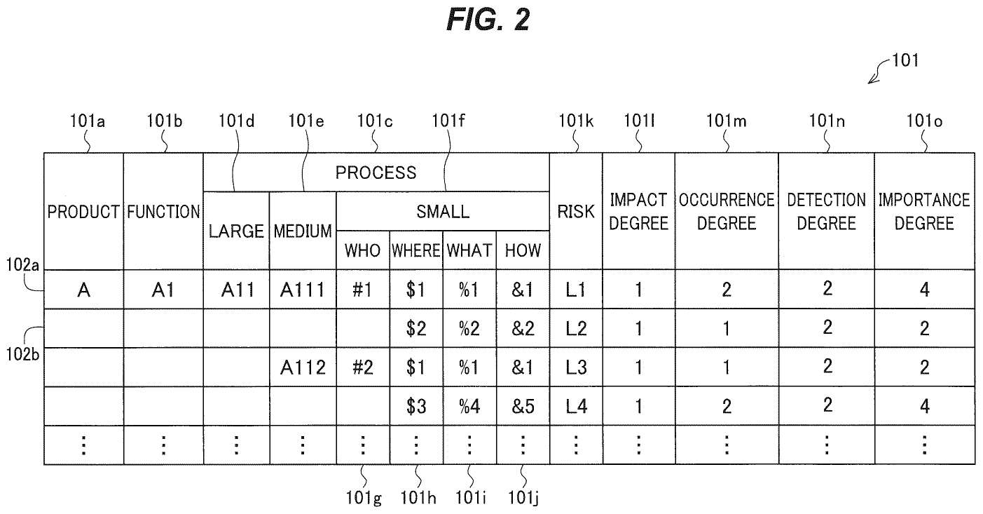

FIG. 2 is a schematic diagram illustrating the FMEA sheet.

An FMEA sheet 101 illustrated is table-format data that includes a product column 101a, a function column 101b, a process column 101c, a risk column 101k, an impact degree column 101l, an occurrence degree column 101m, a detection degree column 101n, and an importance degree column 1010. Each of these columns stores an item.

The product column 101a stores product identification information, such as a product name for identifying a product to be manufactured by an operation process.

The function column 101b stores function identification information, such as a function name for identifying the function of the product.

As described above, the product column 101a and the function column 101b store product information for specifying the product.

The process column 101c stores operation process information indicative of an operation process for manufacturing the product.

Here, the process column 101c is divided into a large process column 101d, a medium process column 101e, and a small process column 101f. The small process column 101f is further divided into a “who” column 101g, a “where” column 101h, a “what” column 101i, and a “how” column 101j.

In other words, the operation process is classified into respective large, medium, and small processes, and in the small process, a single operation process in which a person performs a certain thing at a certain location is managed.

The risk column 101k stores a risk sentence, which is a sentence that shows information about a risk in a single operation process.

The impact degree column 101l stores the degree of risk impact.

The occurrence degree column 101m stores the degree of risk occurrence.

The detection degree column 101n stores the degree of risk detection.

The importance degree column 1010 stores the degree of risk importance.

As described above, respective evaluation values, which have been obtained by evaluating the risk, are stored in the impact degree column 101l, the occurrence degree column 101m, the detection degree column 101n, and the importance degree column 1010. Hereinafter, the information stored in the impact degree column 101l, the occurrence degree column 101m, the detection degree column 101n, and the importance degree column 1010 is also referred to as evaluation information.

The FMEA sheet is configured as described above. FMEA sheets created in the past are stored in the storage unit 120 as past case sheets as mentioned later.

It is noted that a blank cell on the FMEA sheet is assumed to have the same content as that of information appearing first in an upper-side cell of the same column.

A plurality of rows included in the FMEA sheet is assumed to be arranged in the order in which the operation processes are performed.

As described above, the FMEA sheet functions as a management sheet that includes a plurality of rows, each of the plurality of rows including at least the operation process information indicative of one operation process included in the plurality of operation processes and a risk sentence indicative of information about a risk in the one operation process.

Returning to FIG. 1, the training data generating unit 111 generates training data from the FMEA sheets created in the past and stored in the storage unit 120. The FMEA sheets created in the past and stored in the storage unit 120 are also referred to as the past case sheets.

The training data generating unit 111 here creates a pair of input and output data as the training data for learning the contents of the past case sheet. Here, the output data is also referred to as ground truth data. In the first embodiment, the training data generating unit 111 generates integrated feature training data for learning an order task as a first task and a word task as a second task, as well as correspondence relationship training data for learning correspondence relationships.

First, the integrated feature training data will be described.

The training data generating unit 111 extracts, as text, at least operation process information, which is information stored in the process column 101c, and a risk sentence, which is information stored in the risk column 101k, among the stored information, in units of two consecutive rows from the top of the past case sheet. It is noted that when there is a blank cell, corresponding information is supplemented and extracted as the text. Here, the product information stored in the product column 101a and the function column 101b is also extracted.

For example, in the FMEA sheet 101 illustrated in FIG. 2, the training data generating unit 111 extracts, as one unit, the product information, the operation process information, and the risk sentence, which are stored in the row 102a, and the product information, the operation process information, and the risk sentence, which are stored in the row 102b.

Then, the training data generating unit 111 performs morphological analysis processing on the text extracted from one row to divide the text into tokens; each token represents the smallest unit of meaning. The training data generating unit 111 arranges the divided tokens in the order in which they appear in the corresponding text to form a character string as sequence data.

The training data generating unit 111 assigns a positive example label to concatenated sequence data, which is data provided by concatenating the sequence data, included in one unit, in the order from the top to the bottom of the past case sheet. Meanwhile, the training data generating unit 111 assigns a negative example label to concatenated sequence data, which is provided by concatenating the sequence data, included in one unit, in the order from the bottom to the top of the past case sheet.

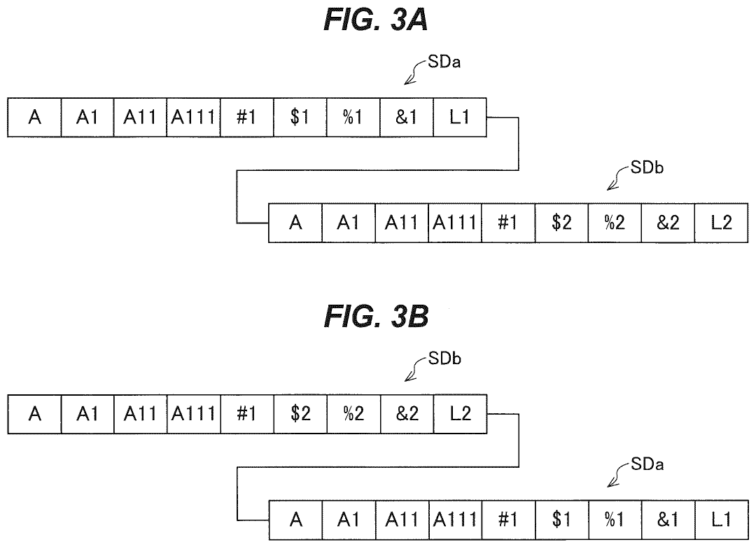

For example, FIGS. 3A and 3B are schematic diagrams, each illustrating an example of concatenated sequence data.

FIGS. 3A and 3B illustrate the examples of the concatenated sequence data extracted from the rows 102a and 102b of the FMEA sheet 101 illustrated in FIG. 2. FIG. 3A illustrates the concatenated sequence data, in which sequence data SDa extracted from the row 102a of the FMEA sheet 101 and sequence data SDb extracted from the row 102b thereof are concatenated in the order of the row 102a, followed by the row 102b. In this case, a positive example label is assigned to this concatenated sequence data.

Meanwhile, FIG. 3B illustrates the concatenated sequence data, in which the sequence data SDa extracted from the row 102a of the FMEA sheet 101 and the sequence data SDb extracted from the row 102b thereof are concatenated in the order of the row 102b, followed by the row 102a. In this case, a negative example label is assigned to this concatenated sequence data.

The concatenated sequence data with the label assigned thereto in the above manner is also referred to as labeled concatenated sequence data.

Next, the training data generating unit 111 replaces some of the plurality of tokens within the concatenated sequence data with a mask token, which is a special token for learning, at a certain probability, thereby generating replaced concatenated sequence data.

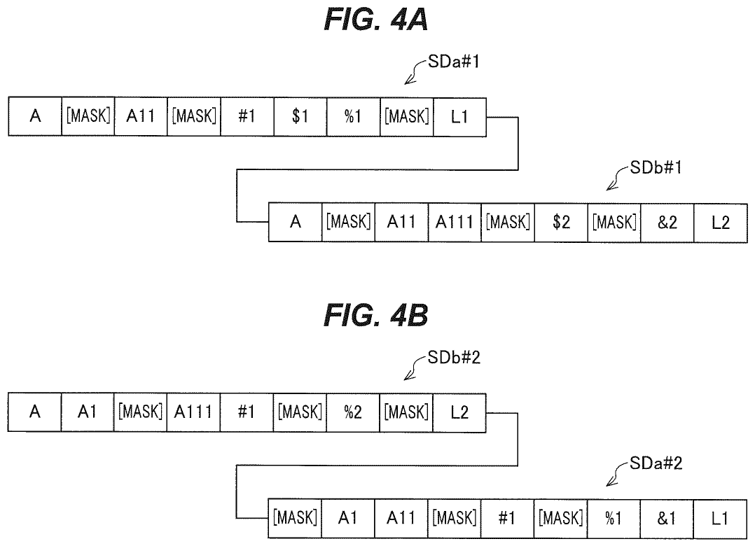

FIGS. 4A and 4B are schematic diagrams, each illustrating an example of the replaced concatenated sequence data.

FIGS. 4A and 4B also illustrate the examples of the concatenated sequence data extracted from the rows 102a and 102b of the FMEA sheet 101 illustrated in FIG. 2.

As illustrated in FIG. 4A, plural tokens are replaced with the special tokens [MASK] in the concatenated sequence data in which the sequence data SDa extracted from the row 102a of the FMEA sheet 101 and the sequence data SDb extracted from the row 102b thereof are concatenated in the order of the row 102a, followed by the row 102b.

In FIG. 4A, in the sequence data SDa, data in which one or more tokens are replaced with the special tokens [MASK] is designated as SDa#1, while in the sequence data SDb, data in which one or more tokens are replaced with the special tokens [MASK] is designated as SDb#1. However, the replacement of the tokens with the special tokens is not limited to this example and only needs to be performed at random.

Meanwhile, as illustrated in FIG. 4B, plural tokens are replaced with the special tokens [MASK] in the concatenated sequence data in which the sequence data SDa extracted from the row 102a of the FMEA sheet 101 and the sequence data SDb extracted from the row 102b thereof are concatenated in the order of the row 102b, followed by the row 102a.

In FIG. 4B, in the sequence data SDa, data in which one or more tokens are replaced with the special tokens [MASK] is designated as SDa#2, while in the sequence data SDb, data in which one or more tokens are replaced with the special tokens [MASK] is designated as SDb#2. However, the replacement of the tokens with the special tokens is not limited to this example and only needs to be performed at random.

The integrated feature training data is configured by pairing the above replaced concatenated sequence data as input data with the above labeled concatenated sequence data as output data.

In other words, the training data generating unit 111 extracts two consecutive rows from the plurality of rows on the FMEA sheet, namely a first row and a second row that is subsequent to the first row. Then, the training data generating unit 111 specifies a plurality of first tokens, which are a plurality of tokens, by performing morphological analysis on the operation process information and the risk sentence included in the first row, and arranges the plurality of first tokens, thereby generating first sequence data. In addition, the training data generating unit 111 specifies a plurality of second tokens, which are a plurality of tokens, by performing morphological analysis on the operation process information and the risk sentence included in the second row, and arranges the plurality of second tokens, thereby generating second sequence data. The training data generating unit 111 concatenates the first sequence data and the second sequence data in the order of the first sequence data, followed by the second sequence data, thereby generating first concatenated sequence data. In addition, the training data generating unit 111 concatenates the first sequence data and the second sequence data in the order of the second sequence data, followed by the first sequence data, thereby generating second concatenated sequence data. The training data generating unit 111 changes one or more tokens randomly selected from the plurality of first and second tokens included in the first concatenated sequence data, into a mask token(s) designed to obscure the meaning of the token(s), thereby generating first input data. In addition, the training data generating unit 111 changes one or more tokens randomly selected from the plurality of first and second tokens included in the second concatenated sequence data, into a mask token(s), thereby generating second input data. Then, the training data generating unit 111 attaches a positive example label to the first concatenated sequence data, thereby generating first labeled concatenated sequence data as first output data, which is output data for the first input data. In addition, the training data generating unit 111 attaches a negative example label to the second concatenated sequence data, thereby generating second labeled concatenated sequence data as second output data, which is output data for the second input data. Thus, the training data generating unit 111 generates the integrated feature training data, which is the training data composed of the first input and output data and the second input and output data.

Next, the correspondence relationship training data will be described.

The training data generating unit 111 extracts, as the text, at least the operation process information, which is the information stored in the process column 101c, and the risk sentence, which is the information stored in the risk column 101k, among the stored information in a row unit of the past case sheet. It is noted that when there is a blank cell, the corresponding information is supplemented and extracted as the text. Here, the product information stored in the product column 101a and the function column 101b is also extracted.

Then, the training data generating unit 111 performs morphological analysis processing on the text extracted from one row to divide the text into tokens; each token represents the smallest unit of meaning. The training data generating unit 111 arranges the divided tokens in the order in which they appear in the corresponding text to form a character string as sequence data.

The training data generating unit 111 sets a part of the sequence data, excluding the risk sentences, as sheet structure information.

Then, the training data generating unit 111 combines the sheet structure information in one sequence data with a risk sentence in another sequence data to form combined sequence data. Here, each of the risk sentences of all other sequence data is assumed to be combined with the sheet structure information in the one sequence data.

The training data generating unit 111 sets the above sequence data and combined sequence data as input sequence data, which is the input data for learning correspondence relationships.

The training data generating unit 111 attaches a positive example label to the sequence data and also attaches a negative example label to the combined sequence data.

Then, the training data generating unit 111 sets the labeled sequence data and the labeled combined sequence data as output sequence data, which is the output data for learning correspondence relationships. The above input sequence data and output sequence data constitute the correspondence relationship training data.

As described above, the training data generating unit 111 generates the correspondence relationship training data, which is the training data including the positive example and the negative example. The positive example is a combination of the operation process information included in one of the plurality of rows in the past case sheet and the risk sentence included in the one row. The negative example is a combination of the operation process information included in the one row and a risk sentence included in a row different from the one row.

The integrated feature learning unit 112 executes learning by using the integrated feature training data generated by the training data generating unit 111, to generate an integrated feature model, which is a machine learning model. The generated integrated feature model is stored in the storage unit 120.

For example, the integrated feature learning unit 112 generates the integrated feature model by learning the tokens before executing the replacement into the mask tokens from the integrated feature training data, and also by learning the order of an arrangement of the first sequence data and the second sequence data.

The machine learning in the integrated feature learning unit 112 may employ known methods described in the literature below.

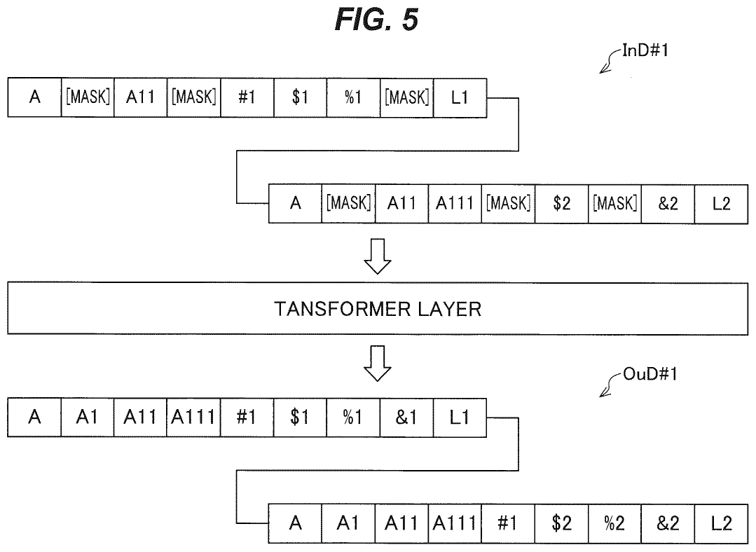

Literature: Jacob Devlin, Ming-Wei Chang, Kenton Lee, Kristina Toutanova, “BERT: Pre-training of deep bidirectional transformers for language understanding”, arXiv preprint arXiv: 1810. 04805v2, 2019 FIG. 5 is a schematic diagram for explaining machine learning in the integrated feature learning unit 112.

As illustrated in FIG. 5, by using the replaced concatenated sequence data InD #1 as the input data and the labeled concatenated sequence data OuD #1 as the output data, the integrated feature learning unit 112 learns a word task that estimates original tokens for special tokens in the replaced concatenated sequence data InD #1, so that it can learn the features of the FMEA sheet in the row direction. In addition, when the order of the arrangement of the sequence data included in the replaced concatenated sequence data InD #1 matches the order of the operation processes, the integrated feature learning unit 112 learns this as the positive example. On the other hand, when it does not match, the integrated feature learning unit 112 learns this as the negative example. Consequently, it can learn the features of the FMEA sheet in the column direction.

By the machine learning of these two tasks in a multitasking manner, the integrated feature learning unit 112 can acquire, as neural network parameters, the feature quantities in which the structural features of the FMEA sheet and the linguistic features within the FMEA sheet are integrated.

Returning to FIG. 1, the correspondence relationship learning unit 113 executes learning by using the correspondence relationship training data generated by the training data generating unit 111, to generate the correspondence relationship model, which is a machine learning model. The generated correspondence relationship model is stored in the storage unit 120.

For example, the correspondence relationship learning unit 113 generates the correspondence relationship model by learning at least the correspondence relationship between the operation process information and the risk sentence through use of the correspondence relationship training data.

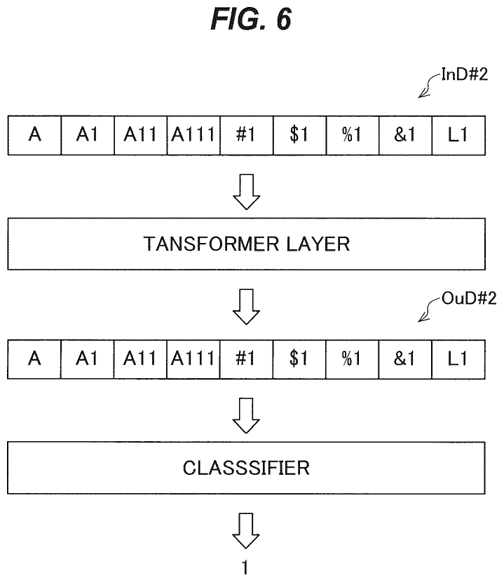

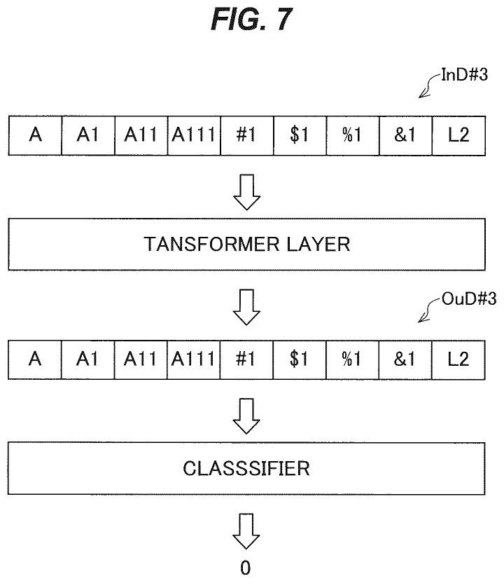

FIGS. 6 and 7 are schematic diagrams for explaining machine learning in the correspondence relationship learning unit 113.

As illustrated in FIG. 6, when the input sequence data InD #2 matches the output sequence data OuD #2 attached with a positive example label, the correspondence relationship learning unit 113 determines this as a positive example “1”. In contrast, as illustrated in FIG. 7, when the input sequence data InD #3 matches the output sequence data OuD #3 attached with a negative example label, the correspondence relationship learning unit 113 determines this as a negative example “0”.

Through the above learning, the correspondence relationship between the structure of the FMEA sheet and the risk sentence can be learned. In particular, the correspondence relationship between the operation process information and the risk sentence can be learned.

The correspondence relationship learning unit 113 can enhance learning accuracy of the correspondence relationship by using the parameters of the integrated feature model as initial value parameters of the neural network used in machine learning.

Returning to FIG. 1, the storage unit 120 stores data and programs necessary for processing in the FMEA sheet creation support device 100.

The storage unit 120 includes a past case sheet storage unit 121, an integrated feature model storage unit 122, a document storage unit 123, and a correspondence relationship model storage unit 124.

The past case sheet storage unit 121 stores past case sheets, which are FMEA sheets created in the past.

The integrated feature model storage unit 122 stores the integrated feature model generated by the integrated feature learning unit 112.

The document storage unit 123 stores a plurality of documents, which are searched for when the FMEA sheet is created.

The correspondence relationship model storage unit 124 stores the correspondence relationship model generated by the correspondence relationship learning unit 113.

The search processing unit 130 performs processing to search for information necessary when the FMEA sheet is created.

The search processing unit 130 includes an information acquisition unit 131, a correspondence relationship estimation unit 132, and a display processing unit 133.

The information acquisition unit 131 acquires search information, which is information for search.

Here, the information acquisition unit 131 acquires the search information by receiving an input from a user via the input unit 140.

In the first embodiment, the search information is assumed to include at least operation process information, and it is described here as including the product information and the operation process information. For this reason, the search information is also referred to as search operation process information, which is operation process information for search.

The correspondence relationship estimation unit 132 estimates information necessary when the FMEA sheet is created, by using the search information, the document stored in the document storage unit 123, and the correspondence relationship model stored in the correspondence relationship model storage unit 124.

For example, the correspondence relationship estimation unit 132 generates a plurality of pieces of search sequence data by concatenating the respective plurality of sentences included in each of the documents stored in the document storage unit 123, with the search information.

Next, the correspondence relationship estimation unit 132 acquires a score for each of the plurality of pieces of search sequence data by inputting each piece of search sequence data into the correspondence relationship model.

The correspondence relationship estimation unit 132 then sums the acquired scores for each document and specifies a document with the highest summed value as reference information.

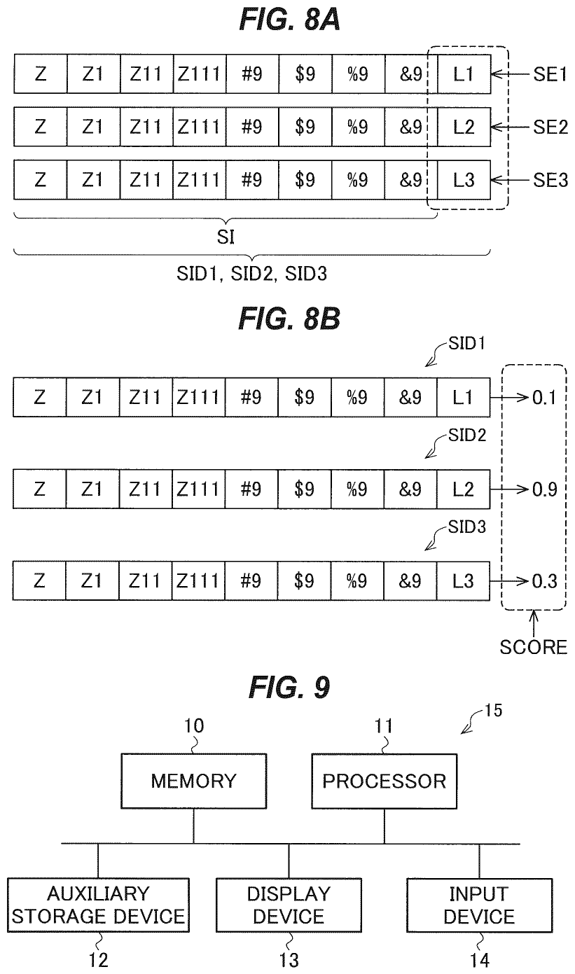

FIGS. 8A and 8B are schematic diagrams for explaining processing performed in the correspondence relationship estimation unit 132.

As illustrated in FIG. 8A, the correspondence relationship estimation unit 132 generates search sequence data SID1, SID2, and SID3 by concatenating a plurality of sentences SE1, SE2, and SE3 included in a document stored in the document storage unit 123, with search information SI, respectively.

Next, as illustrated in FIG. 8B, the correspondence relationship estimation unit 132 acquires scores for the respective search sequence data SID1, SID2, and SID3 by inputting each of these search sequence data into the correspondence relationship model.

The correspondence relationship estimation unit 132 then sums the acquired scores for each document and specifies a document with the highest summed value as the reference information.

In other words, the correspondence relationship estimation unit 132 generates the plurality of pieces of search sequence data by adding each of the plurality of sentences included in the plurality of documents to the search operation process information. Subsequently, the correspondence relationship estimation unit 132 sums a plurality of scores obtained by inputting the plurality of pieces of search sequence data into the correspondence relationship model, for each of the plurality of documents, each including the plurality of sentences. Then, the correspondence relationship estimation unit 132 specifies the document with the highest summed score as the reference information.

The display processing unit 133 generates a reference screen image showing the reference information and displays the reference screen image on the display unit 150.

The input unit 140 receives an input from the user.

The display unit 150 displays various screen images.

The FMEA sheet creation support device 100 described above can be implemented by a computer 15, such as that illustrated in FIG. 9.

The computer 15 includes a memory 10, a processor 11 such as a Central Processing Unit (CPU), an auxiliary storage device 12 such as a Hard Disk Drive (HDD) or Solid State Drive (SSD), a display device 13 such as a display, and an input device 14 such as a mouse or keyboard.

A part or all of the preprocessing unit 110 and the search processing unit 130 can be constituted by, for example, the memory 10 and the processor 11 such as a Central Processing Unit (CPU) that executes a program stored in the memory 10.

Such a program may be provided over a network, or may be provided while being recorded on a recording medium. That is, such a program may be provided, for example, as a program product.

The storage unit 120 can be implemented by the auxiliary storage device 12 or storage.

The display unit 150 can be implemented by the display device 13 or display.

The input unit 140 can be implemented by the input device 14 or input interface.

As described above, according to the first embodiment, information on a document in which a useful sentence is described can be provided to a user when the user creates an FMEA sheet.

### Second Embodiment

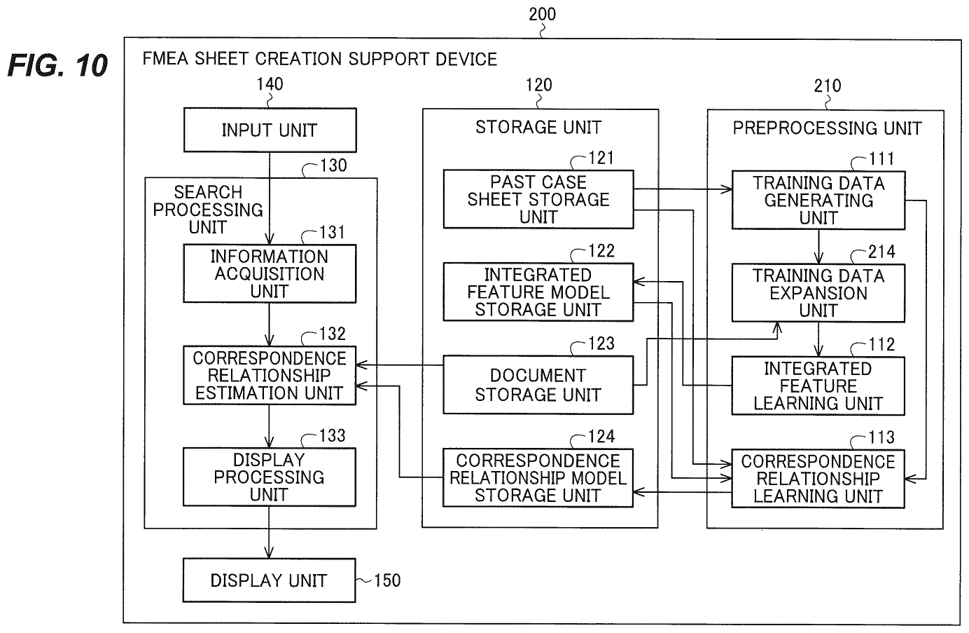

FIG. 10 is a block diagram schematically illustrating a configuration of an FMEA sheet creation support device 200 according to a second embodiment.

The FMEA sheet creation support device 200 includes a preprocessing unit 210, the storage unit 120, the search processing unit 130, the input unit 140, and the display unit 150.

The storage unit 120, the search processing unit 130, the input unit 140, and the display unit 150 in the FMEA sheet creation support device 200 according to the second embodiment are the same as the storage unit 120, the search processing unit 130, the input unit 140, and the display unit 150 in the FMEA sheet creation support device 100 according to the first embodiment, respectively.

The preprocessing unit 210 functions as a learning unit that learns learning models to be used in the search processing unit 130.

The preprocessing unit 210 includes the training data generating unit 111, the integrated feature learning unit 112, the correspondence relationship learning unit 113, and a training data expansion unit 214.

The training data generating unit 111, the integrated feature learning unit 112, and the correspondence relationship learning unit 113 of the preprocessing unit 210 in the second embodiment are the same as the training data generating unit 111, the integrated feature learning unit 112, and the correspondence relationship learning unit 113 of the preprocessing unit 110 in the first embodiment, respectively.

It is noted that the training data generating unit 111 provides the generated integrated feature training data to the training data expansion unit 214.

The integrated feature learning unit 112 performs learning by using the integrated feature training data expanded by the training data expansion unit 214.

The training data expansion unit 214 sets at least one token included in the sheet structure information as a search query in the labeled concatenated sequence data included in the integrated feature training data generated by the training data generating unit 111. The training data expansion unit 214 then specifies a sentence including such a token by searching through documents stored in the document storage unit 123.

The training data expansion unit 214 then generates new integrated feature training data from the integrated feature training data by replacing the specified sentence with a risk sentence of the sheet structure information including the search query. By adding the newly generated integrated feature training data to the integrated feature training data generated by the training data generating unit 111, the training data expansion unit 214 expands the integrated feature training data generated by the training data generating unit 111.

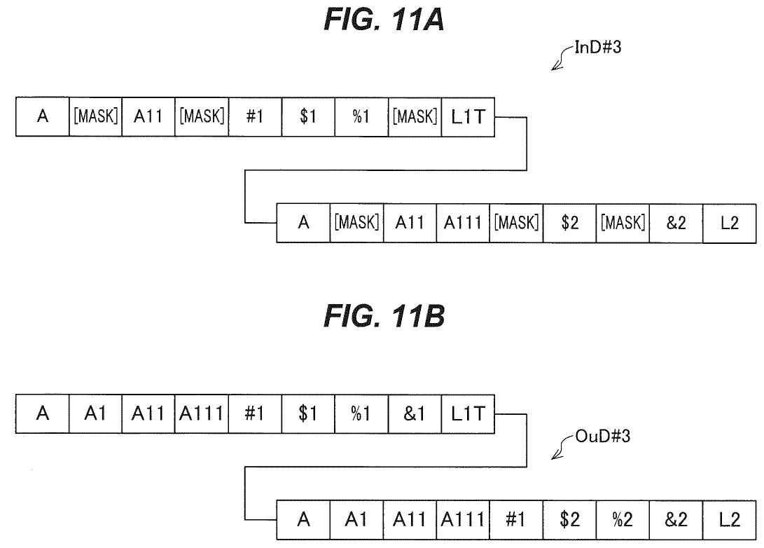

FIG. 11 is a schematic diagram illustrating an example of expanding the integrated feature training data.

In FIG. 11, an example is illustrated in which new replaced concatenated sequence data InD #3 and new labeled concatenated sequence data OuD #3 are generated from the replaced concatenated sequence data InD #1 and the labeled concatenated sequence data OuD #1 illustrated in FIG. 5.

As illustrated in FIG. 11, in the new replaced concatenated sequence data InD #3 and the new labeled concatenated sequence data OuD #3, the risk sentence L1 included in the replaced concatenated sequence data InD #1 and the labeled concatenated sequence data OuD #1 illustrated in FIG. 5 is replaced with a sentence LIT that is specified by searching through the documents stored in the document storage unit 123 by the use of at least one of “A”, “A1”, “A11”, “#1”, “$1”, “% 1” and “&1” as the search query.

In FIG. 11, since the sentence LIT has been specified by at least one search query of “$1”, “% 1”, and “&1”, which are included only in the former part of the sequence data, the risk sentence L1 is replaced with the sentence LIT. However, when the sentence has been specified by at least one search query of “A”, “A1”, “A11” and “#1”, included in both the sequence data, each of the risk sentences L1 and L2 is replaced with the specified sentence.

Further, when the sentence is specified by at least one search query of “$2”, “% 2”, and “&2”, which are included only in the latter part of the sequence data, only the risk sentence L2 may be replaced with the specified sentence.

In other words, in the second embodiment, the training data expansion unit 214 generates expanded integrated feature training data from the integrated feature training data by performing at least one of the following processes: replacement of the risk sentence included in the first sequence data with the sentence detected by searching through the plurality of documents by using the operation process information included in the first sequence data, and replacement of the risk sentence included in the second sequence data with the sentence detected by searching through the plurality of documents by using the operation process information included in the second sequence data.

Then, the integrated feature learning unit 112 also learns the expanded integrated feature training data to generate the integrated feature model.

As described above, according to the second embodiment, in addition to a combination of the sheet structure information and the risk sentence, a combination of the sheet structure information and a sentence included in the relevant document can be used as new training data, thus expanding the training data.

### Third Embodiment

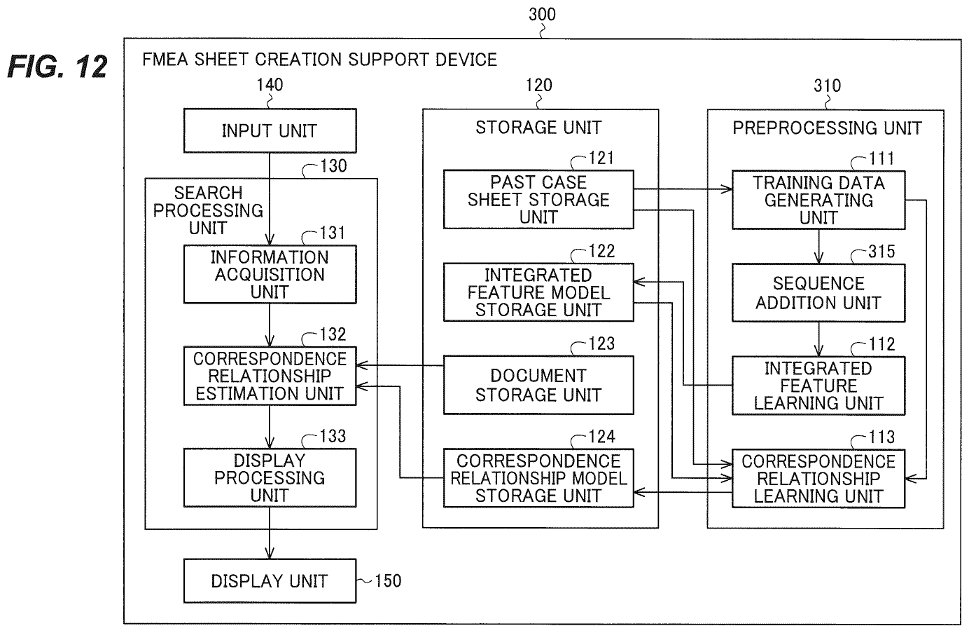

FIG. 12 is a block diagram schematically illustrating a configuration of an FMEA sheet creation support device 300 according to a third embodiment.

The FMEA sheet creation support device 300 includes a preprocessing unit 310, the storage unit 120, the search processing unit 130, the input unit 140, and the display unit 150.

The storage unit 120, the search processing unit 130, the input unit 140, and the display unit 150 in the FMEA sheet creation support device 300 according to the third embodiment are the same as the storage unit 120, the search processing unit 130, the input unit 140, and the display unit 150 of the FMEA sheet creation support device 100 according to the first embodiment, respectively.

The preprocessing unit 310 functions as a learning unit that learns learning models to be used in the search processing unit 130.

The preprocessing unit 310 includes the training data generating unit 111, the integrated feature learning unit 112, the correspondence relationship learning unit 113, and a sequence addition unit 315.

The training data generating unit 111, the integrated feature learning unit 112, and the correspondence relationship learning unit 113 of the preprocessing unit 310 in the third embodiment are the same as the training data generating unit 111, the integrated feature learning unit 112, and the correspondence relationship learning unit 113 of the preprocessing unit 110 in the first embodiment, respectively.

However, the integrated feature learning unit 112 also performs learning by using, as input data, the concatenated sequence data that has been added by the sequence addition unit 315.

The sequence addition unit 315 adds additional concatenated sequence data, which is concatenated sequence data that stores information indicative of the contents of each item, as input data for the integrated feature training data generated by the training data generating unit 111.

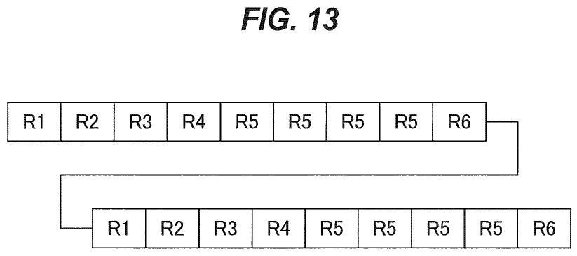

FIG. 13 is a schematic diagram illustrating an example of the additional concatenated sequence data.

The additional concatenated sequence data stores information indicative of the contents represented by each information included in the replaced concatenated sequence data used as the input data for the integrated feature training data.

For example, in FIG. 13, “R1” is information indicative of “product identification information”, “R2” is information indicative of “function identification information”, “R3” is information indicative of a “large process”, which is the classification of the operation process, “R4” is information indicative of a “medium process”, which is the classification of the operation process, “R5” is information indicative of a “small process”, which is the classification of the operation process, and “R6” is information indicative of a “risk sentence”.

In other words, in the third embodiment, the sequence addition unit 315 adds, to each of the first and second input data, additional sequence data indicative of the contents of the plurality of first and second tokens before being changed to the mask tokens.

According to the third embodiment, the structural information on the FMEA sheet can be explicitly provided by adding the additional concatenated sequence data as the input data during the learning performed by the integrated feature learning unit 112, thus improving the accuracy of machine learning.

### Fourth Embodiment

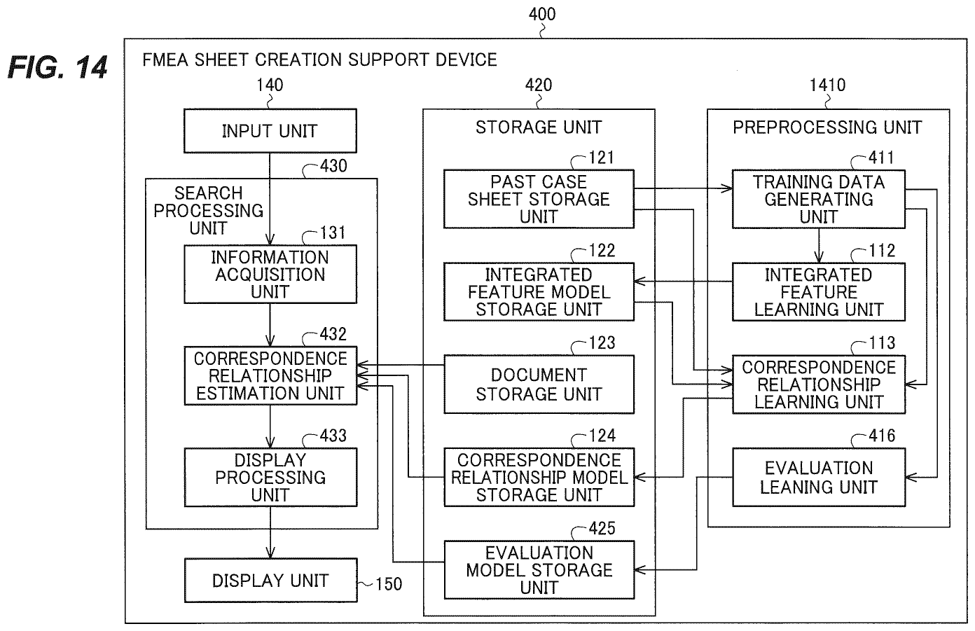

FIG. 14 is a block diagram schematically illustrating a configuration of an FMEA sheet creation support device 400 according to a fourth embodiment.

The FMEA sheet creation support device 400 includes a preprocessing unit 410, a storage unit 420, a search processing unit 430, the input unit 140, and the display unit 150.

The input unit 140 and the display unit 150 in the FMEA sheet creation support device 400 according to the fourth embodiment are the same as the input unit 140 and the display unit 150 in the FMEA sheet creation support device 100 according to the first embodiment, respectively.

The preprocessing unit 410 functions as a learning unit that learns learning models to be used in the search processing unit 430.

The preprocessing unit 410 includes a training data generating unit 411, the integrated feature learning unit 112, the correspondence relationship learning unit 113, and an evaluation learning unit 416.

The integrated feature learning unit 112 and the correspondence relationship learning unit 113 of the preprocessing unit 410 in the fourth embodiment are the same as the integrated feature learning unit 112 and the correspondence relationship learning unit 113 of the preprocessing unit 110 in the first embodiment, respectively.

The training data generating unit 411 generates not only the integrated feature training data and the correspondence relationship training data as in the first embodiment, and generates also evaluation training data for learning in the evaluation learning unit 416. For example, the training data generating unit 411 acquires product information, operation process information, a risk sentence, and evaluation information from each row of the past case sheets stored in the past case sheet storage unit 121, and it generates evaluation training data that includes the product information, the operation process information, and the risk sentence as input data, and also includes the product information, the operation process information, the risk sentence and the evaluation information as output data.

The generated evaluation training data is provided to the evaluation learning unit 416.

The evaluation learning unit 416 generates an evaluation model, which is a machine learning model, by learning by the use of the evaluation training data generated by the training data generating unit 411. The generated evaluation model is stored in the storage unit 420.

The evaluation learning unit 416 can use the parameters of the integrated feature model as initial value parameters of the neural network used in the machine learning, thereby enhancing the learning accuracy of the correspondence relationship.

The storage unit 420 stores data and programs necessary for the processing in the FMEA sheet creation support device 400.

The storage unit 420 includes the past case sheet storage unit 121, the integrated feature model storage unit 122, the document storage unit 123, the correspondence relationship model storage unit 124, and an evaluation model storage unit 425.

The past case sheet storage unit 121, the integrated feature model storage unit 122, the document storage unit 123, and the correspondence relationship model storage unit 124 of the storage unit 420 in the fourth embodiment are the same as the past case sheet storage unit 121, the integrated feature model storage unit 122, the document storage unit 123, and the correspondence relationship model storage unit 124 of the storage unit 120 in the first embodiment, respectively.

The evaluation model storage unit 425 stores the evaluation model generated by the evaluation learning unit 416.

The search processing unit 430 performs processing to search for information necessary when the FMEA sheet is created.

The search processing unit 430 includes the information acquisition unit 131, a correspondence relationship estimation unit 432, and a display processing unit 433.

The information acquisition unit 131 of the search processing unit 430 in the fourth embodiment is the same as the information acquisition unit 131 of the search processing unit 130 in the first embodiment.

The correspondence relationship estimation unit 432 specifies, as the reference information, a document that is the most compatible with the search information by using the search information, the document stored in the document storage unit 123, and the correspondence relationship model stored in the correspondence relationship model storage unit 124, as in the first embodiment.

In addition, the correspondence relationship estimation unit 432 generates evaluation search sequence data by concatenating one or more sentences included in the document specified as the reference information, with the search information.

The correspondence relationship estimation unit 432 may concatenate all sentences included in the document specified as the reference information with the search information. Alternatively, it here concatenates a predetermined number of sentences, selected from among those in order of high score, with the search information to thereby generate the evaluation search sequence data.

Then, the correspondence relationship estimation unit 432 estimates the evaluation information in the evaluation search sequence data by inputting the evaluation search sequence data into the evaluation model stored in the evaluation model storage unit 425. The estimated evaluation information is provided to the display processing unit 433.

The display processing unit 433 generates a reference screen image showing the reference information and the evaluation information and causes the display unit 150 to display the reference screen image.

In other words, in the fourth embodiment, the training data generating unit 411 generates the evaluation training data, which is the training data including the operation process information included in one of the plurality of rows in the past case sheet as the input data and the operation process information and the risk sentence included in the one row as the output data. Then, the evaluation learning unit 416 generates the evaluation model by learning the risk sentence from the operation process information by the use of the evaluation training data.

Further, the correspondence relationship estimation unit 432 generates evaluation estimation sequence data by adding, to the search operation process information, one or more sentences selected from among the plurality of sentences included in the document specified as the reference information. It estimates the evaluation for the evaluation estimation sequence data by inputting the generated evaluation estimation sequence data into the evaluation model. Then, the display processing unit 433 also displays the estimated evaluation in the screen image.

As described above, according to the fourth embodiment, the evaluation information when the document specified as the reference information is used can be estimated.

In the first to fourth embodiments described above, the learning of the correspondence relationship model or evaluation model is performed by using, as the initial parameters, the parameters of the integrated feature model that have been learned in the integrated feature learning unit 112. However, the first to fourth embodiments are not limited to this example. For example, when a sufficient amount of training data can be prepared to learn the correspondence relationship model or evaluation model, the correspondence relationship model or evaluation model may be learned without learning the integrated feature model.

Although the FMEA sheet creation support devices 100 to 400 described above have both learning and inference functions, the first to fourth embodiments are not limited to these examples.

For example, a learning device (not shown) may be constituted by a portion that performs a learning function and includes, for example, the preprocessing units 110-410, the storage unit 120, 420, the input unit 140, and the display unit 150. An inference device (not shown) or management sheet creation support device may be constituted by a portion that performs an inference function and includes, for example, the storage unit 120, 420, the search processing unit 130, 430, the input unit 140, and the display unit 150.

The storage unit 120, 420 may be included in an external device.

What is claimed is:

1. A learning device comprising:
storage to store a past case sheet created in a past as a management sheet, the management sheet including a plurality of rows, each of the plurality of rows including at least operation process information indicative of one operation process included in a plurality of operation processes and a risk sentence indicative of information about a risk in the one operation process;
a processor to execute a program; and
a memory to store the program which, when executed by the processor, performs processes of,
generating correspondence relationship training data, which is training data including a positive example and a negative example, the positive example being a combination of the operation process information included in one of the plurality of rows in the past case sheet and the risk sentence included in the one row, the negative example being a combination of the operation process information included in the one row and the risk sentence included in a row different from the one row; and
generating a correspondence relationship model by learning a correspondence relationship between the operation process information and the risk sentence by using the correspondence relationship training data.

2. The learning device according to claim 1,
wherein the plurality of rows is arranged in order in which the plurality of operation processes is performed,
wherein the processor
extracts two consecutive rows from the plurality of rows, the two rows being a first row and a second row that is subsequent to the first row;
specifies a plurality of first tokens, which are a plurality of tokens, by performing morphological analysis on the operation process information and the risk sentence included in the first row, and then arrange the plurality of first tokens, thereby generating first sequence data;
specifies a plurality of second tokens, which are a plurality of tokens, by performing morphological analysis on the operation process information and the risk sentence included in the second row, and then arrange the plurality of second tokens, thereby generating second sequence data;
concatenates the first sequence data and the second sequence data in order of the first sequence data, followed by the second sequence data, thereby generating first concatenated sequence data;
concatenates the first sequence data and the second sequence data in order of the second sequence data, followed by the first sequence data, thereby generating second concatenated sequence data;
changes one or more tokens randomly selected from the plurality of first and second tokens included in the first concatenated sequence data, into a mask token designed to obscure meaning of the token, thereby generating first input data;
changes one or more tokens randomly selected from the plurality of first and second tokens included in the second concatenated sequence data, into the mask token, thereby generating second input data;
attaches a positive example label to the first concatenated sequence data, thereby generating first labeled concatenated sequence data as first output data, which is output data for the first input data;
attaches a negative example label to the second concatenated sequence data, thereby generating second labeled concatenated sequence data as second output data, which is output data for the second input data;
generates integrated feature training data, which is training data including the first input data and the first output data and the second input data and the second output data;
generates an integrated feature model by learning the token before replacement into the mask token, from the integrated feature training data, and also by learning order of an arrangement of the first sequence data and the second sequence data; and
learns the correspondence relationship model by using a parameter of the integrated feature model as an initial parameter.

3. The learning device according to claim 2, wherein
the storage stores a plurality of documents;
the processor generates expanded integrated feature training data from the integrated feature training data by performing at least one of two processes, the two processes including replacement of the risk sentence included in the first sequence data with a sentence which is detected by searching through the plurality of documents by using the operation process information included in the first sequence data and replacement of the risk sentence included in the second sequence data with a sentence which is detected by searching through the plurality of documents by using the operation process information included in the second sequence data; and
the processor learns the expanded integrated feature training data to generate the integrated feature model.

4. The learning device according to claim 2, wherein
the processor adds, to each of the first and second input data, additional sequence data indicative of contents of the plurality of first and second tokens before being changed to the mask tokens.

5. The learning device according to claim 1, wherein the processor generates evaluation training data, which is training data including the operation process information included in one of the plurality of rows in the past case sheet as input data and the operation process information and the risk sentence included in the one row as output data; and
the processor generates an evaluation model by learning the risk sentence from the operation process information through use of the evaluation training data.

6. The learning device according to claim 2, wherein the processor generates evaluation training data, which is training data including the operation process information included in one of the plurality of rows in the past case sheet as input data and the operation process information and the risk sentence included in the one row as output data; and the processor generates an evaluation model by learning the risk sentence from the operation process information through use of the evaluation training data.

7. The learning device according to claim 3, wherein the processor generates evaluation training data, which is training data including the operation process information included in one of the plurality of rows in the past case sheet as input data and the operation process information and the risk sentence included in the one row as output data; and the processor generates an evaluation model by learning the risk sentence from the operation process information through use of the evaluation training data.

8. The learning device according to claim 4, wherein the processor generates evaluation training data, which is training data including the operation process information included in one of the plurality of rows in the past case sheet as input data and the operation process information and the risk sentence included in the one row as output data; and the processor generates an evaluation model by learning the risk sentence from the operation process information through use of the evaluation training data.

9. A management sheet creation support device, comprising:
storage to store a correspondence relationship model for a past case sheet created in a past as a management sheet and a plurality of documents, the management sheet including a plurality of rows, each of the plurality of rows including at least operation process information indicative of one operation process included in a plurality of operation processes and a risk sentence indicative of information about a risk in the one operation process, the correspondence relationship model being generated by learning a correspondence relationship between the operation process information and the risk sentence through use of correspondence relationship training data, which is training data including a positive example and a negative example, the positive example being a combination of the operation process information included in one of the plurality of rows and the risk sentence included in the one row, the negative example being a combination of the operation process information included in the one row and a risk sentence included in a row different from the one row;
a processor to execute a program; and
a memory to store the program which, when executed by the processor, performs processes of,
acquiring search operation process information, which is operation process information for search;
generating a plurality of pieces of search sequence data by adding each of a plurality of sentences included in the plurality of documents to the search operation process information, sum a plurality of scores obtained by inputting the plurality of pieces of search sequence data into the correspondence relationship model, for each of the plurality of documents, each including the plurality of sentences, and then specify a document with a highest summed score as reference information; and
generating a screen image for displaying the reference information.

10. The management sheet creation support device according to claim 9,
wherein the storage stores an evaluation model, which is a learning model generated by learning the risk sentence from the operation process information through use of an evaluation training data, which is training data including the operation process information included in the one row as input data and the operation process information and the risk sentence included in the one row as output data,
wherein the processor generates evaluation estimation sequence data by adding, to the search operation process information, one or more sentences selected from among the plurality of sentences included in the document specified as the reference information, estimates evaluation for the evaluation estimation sequence data by inputting the evaluation estimation sequence data into the evaluation model, and displays the estimated evaluation in the screen image.

11. A non-transitory computer-readable storage medium storing a program that causes a computer to execute processing comprising:
storing a past case sheet created in a past as a management sheet, the management sheet including a plurality of rows, each of the plurality of rows including at least operation process information indicative of one operation process included in a plurality of operation processes and a risk sentence indicative of information about a risk in the one operation process;
generating correspondence relationship training data, which is training data including a positive example and a negative example, the positive example being a combination of the operation process information included in one of the plurality of rows in the past case sheet and the risk sentence included in the one row, the negative example being a combination of the operation process information included in the one row and the risk sentence included in a row different from the one row; and
generating a correspondence relationship model by learning a correspondence relationship between the operation process information and the risk sentence through use of the correspondence relationship training data.

12. A non-transitory computer-readable storage medium storing a program that causes a computer to execute processing comprising:
storing a correspondence relationship model for a past case sheet created in a past as a management sheet, the management sheet including a plurality of rows, each of the plurality of rows including at least operation process information indicative of one operation process included in a plurality of operation processes and a risk sentence indicative of information about a risk in the one operation process, the correspondence relationship model being generated by learning a correspondence relationship between the operation process information and the risk sentence through use of correspondence relationship training data, which is training data including a positive example and a negative example, the positive example being a combination of the operation process information included in one of the plurality of rows and the risk sentence included in the one row, the negative example being a combination of the operation process information included in the one row and the risk sentence included in a row different from the one row;
storing a plurality of documents;
acquiring search operation process information, which is operation process information for search;
generating a plurality of pieces of search sequence data by adding each of a plurality of sentences included in the plurality of documents to the search operation process information, sum a plurality of scores obtained by inputting the plurality of pieces of search sequence data into the correspondence relationship model, for each of the plurality of documents, each including the plurality of sentences, and then specify a document with a highest summed score as reference information; and
generating a screen image for displaying the reference information.

13. A learning method, comprising;
generating correspondence relationship training data for a past case sheet created in a past as a management sheet, the management sheet including a plurality of rows, each of the plurality of rows including at least operation process information indicative of one operation process included in a plurality of operation processes and a risk sentence indicative of information about a risk in the one operation process, the correspondence relationship training data being training data including a positive example and a negative example, the positive example being a combination of the operation process information included in one of the plurality of rows and the risk sentence included in the one row, the negative example being a combination of the operation process information included in the one row and the risk sentence included in a row different from the one row; and
generating a correspondence relationship model by learning a correspondence relationship between the operation process information and the risk sentence through use of the correspondence relationship training data.

14. A management sheet creation support method, comprising:
acquiring search operation process information, which is operation process information for search;
generating a plurality of pieces of search sequence data by adding each of a plurality of sentences included in a plurality of documents to the search operation process information, generating a correspondence relationship model for a past case sheet created in a past as a management sheet, the management sheet including a plurality of rows, each of the plurality of rows including at least operation process information indicative of one operation process included in a plurality of operation processes and a risk sentence indicative of information about a risk in the one operation process, wherein the correspondence relationship model is generated by learning a correspondence relationship between the operation process information and the risk sentence through use of correspondence relationship training data, which is training data including a positive example and a negative example, the positive example being a combination of the operation process information included in one of the plurality of rows and the risk sentence included in the one row, the negative example being a combination of the operation process information included in the one row and the risk sentence included in a row different from the one row, subsequently summing a plurality of scores obtained by inputting the plurality of pieces of search sequence data into the correspondence relationship model, for each of the plurality of documents, each including the plurality of sentences, and then specifying a document with a highest summed score as reference information; and
generating a screen image for displaying the reference information.
